(19) United States
(12) Patent Application Publication
(10) Pub. No.: US 2025/0048213 A1
(43) Pub. Date: Feb. 6, 2025

(54) ADAPTATIONS BASED ON A SERVICE CONTINUITY REQUIREMENT

(71) Applicant: Lenovo (Singapore) Pte. Ltd., New Tech Park (SG)

(72) Inventors: Emmanouil Pateromichelakis, Viersen (DE); Genadi Velev, Darmstadt (DE)

(21) Appl. No.: 18/697,238

(22) PCT Filed: Nov. 11, 2021
(86) PCT No.: PCT/EP2021/081440

§ 371 Date: Mar. 29, 2024

(30) Foreign Application Priority Data
Oct. 4, 2021 (GR) 20210100670

(51) Int. Cl. H04W 36/00; H04L 43/0805

(52) U.S. Cl. CPC H04W 36/13; H04L 43/0805

(57) ABSTRACT

Apparatuses, methods, and systems are disclosed for adaptations based on a service continuity requirement. One method (700) includes receiving (702) a service continuity requirement for an application of a user equipment. The method (700) includes determining (704) a query corresponding to a slice availability and/or a status at a target service area based on the service continuity requirement. The method (700) includes determining (706) a slice related adaptation for the application to maintain application service continuity based on the service continuity requirement and a slice parameter. The method (700) includes translating (708) the slice related adaptation to a trigger action for transmission to a network entity and/or a management entity. The method (700) includes transmitting (710) the trigger action to the network entity and/or the management entity.

### FIELD

The subject matter disclosed herein relates generally to wireless communications and more particularly relates to adaptations based on a service continuity requirement.

### BACKGROUND

In certain wireless communications networks, devices may move between service areas. In a new service area, devices may not have supported slices.

### BRIEF SUMMARY

Methods for adaptations based on a service continuity requirement are disclosed. Apparatuses and systems also perform the functions of the methods. One embodiment of a method includes receiving, at a control entity, a service continuity requirement for one or more applications of one or more user equipments. In some embodiments, the method includes determining a query corresponding to a slice availability, a status at a target service area, or a combination thereof based on the service continuity requirement. In certain embodiments, the method includes determining a slice related adaptation for the application to maintain application service continuity based on the service continuity requirement and a slice parameter. The slice related adaptation includes: an application mapping to a target slice at the target service area; a slice modification to extend slice availability to the target service area; a dynamic slice instantiation at the target service area; or some combination thereof. In various embodiments, the method includes translating the slice related adaptation to a trigger action for transmission to at least one network entity, at least one management entity, or a combination thereof. In some embodiments, the method includes transmitting the trigger action to the at least one network entity, the at least one management entity, or the combination thereof.

One apparatus for adaptations based on a service continuity requirement includes a control entity. In some embodiments, the apparatus includes a receiver that receives a service continuity requirement for one or more applications of one or more user equipments. In various embodiments, the apparatus includes a processor that: determines a query corresponding to a slice availability, a status at a target service area, or a combination thereof based on the service continuity requirement; determines a slice related adaptation for the application to maintain application service continuity based on the service continuity requirement and a slice parameter, wherein the slice related adaptation includes: an application mapping to a target slice at the target service area; a slice modification to extend slice availability to the target service area; a dynamic slice instantiation at the target service area; or some combination thereof; and translates the slice related adaptation to a trigger action for transmission to at least one network entity, at least one management entity, or a combination thereof. In certain embodiments, the apparatus includes a transmitter that transmits the trigger action to the at least one network entity, the at least one management entity, or the combination thereof.

Another embodiment of a method for adaptations based on a service continuity requirement includes receiving, at a network device, a trigger action. In some embodiments, the method includes determining a network action based on the trigger action. In certain embodiments, the method includes transmitting a response to the trigger action based on a result of the network action.

Another apparatus for adaptations based on a service continuity requirement includes a network device. In some embodiments, the apparatus includes a receiver that receives a trigger action. In various embodiments, the apparatus includes a processor that determines a network action based on the trigger action. In certain embodiments, the apparatus includes a transmitter that transmits a response to the trigger action based on a result of the network action.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for adaptations based on a service continuity requirement;

FIG. 2 is a schematic block diagram illustrating one embodiment of an apparatus that may be used for adaptations based on a service continuity requirement;

FIG. 3 is a schematic block diagram illustrating one embodiment of an apparatus that may be used for adaptations based on a service continuity requirement;

FIG. 4 is a schematic block diagram illustrating one embodiment of a system for application service continuity;

FIG. 5 is a schematic block diagram illustrating one embodiment of a system having an enablement entity;

FIG. 6 is a schematic block diagram illustrating another embodiment of a system having an enablement entity;

FIG. 7 is a flow chart diagram illustrating one embodiment of a method for adaptations based on a service continuity requirement; and

FIG. 8 is a flow chart diagram illustrating another embodiment of a method for adaptations based on a service continuity requirement.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

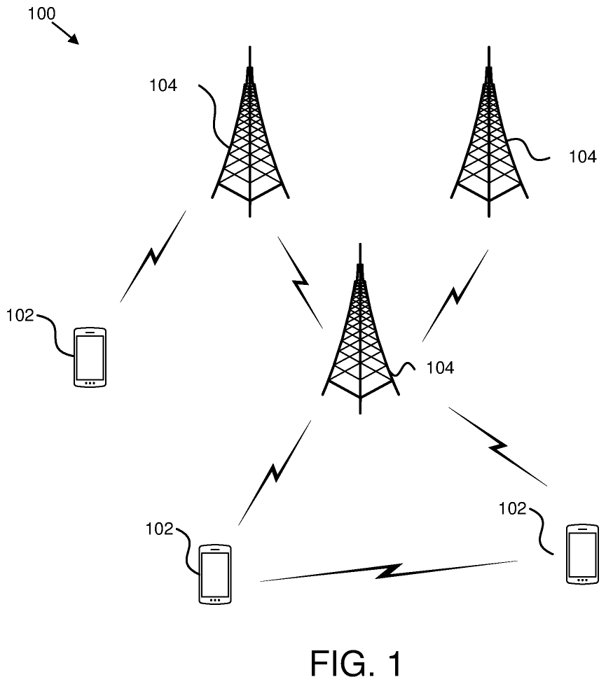

FIG. 1 depicts an embodiment of a wireless communication system 100 for adaptations based on a service continuity requirement. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive a service continuity requirement for one or more applications of one or more user equipments. In some embodiments, the network unit 104 may determine a query corresponding to a slice (e.g., network slice) availability, a status at a target service area, or a combination thereof based on the service continuity requirement. In certain embodiments, the network unit 104 may determine a slice related adaptation for the application to maintain application service continuity based on the service continuity requirement and a slice parameter. The slice related adaptation includes: an application mapping to a target slice at the target service area; a slice modification to extend slice availability to the target service area; a dynamic slice instantiation at the target service area; or some combination thereof. In various embodiments, the network unit 104 may translate the slice related adaptation to a trigger action for transmission to at least one network entity, at least one management entity, or a combination thereof. In some embodiments, the network unit 104 may transmit the trigger action to the at least one network entity, the at least one management entity, or the combination thereof. Accordingly, the network unit 104 may be used for adaptations based on a service continuity requirement.

In certain embodiments, a network unit 104 may receive a trigger action. In some embodiments, the network unit 104 may determine a network action based on the trigger action. In certain embodiments, the network unit 104 may transmit a response to the trigger action based on a result of the network action. Accordingly, the network unit 104 may be used for adaptations based on a service continuity requirement.

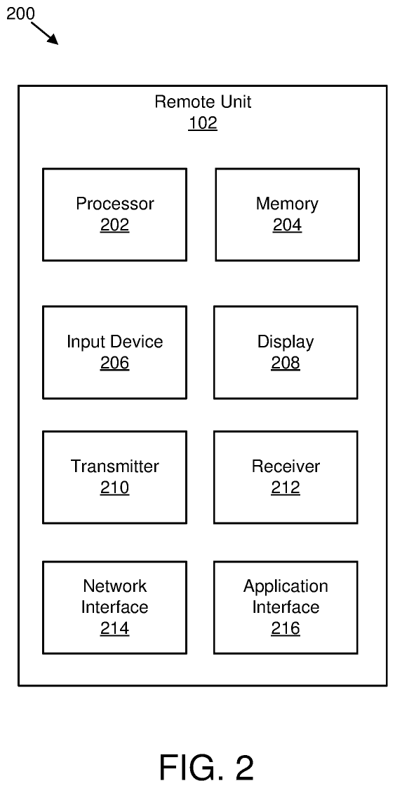

FIG. 2 depicts one embodiment of an apparatus 200 that may be used for adaptations based on a service continuity requirement. The apparatus 200 includes one embodiment of the remote unit 102. Furthermore, the remote unit 102 may include a processor 202, a memory 204, an input device 206, a display 208, a transmitter 210, a receiver 212, a network interface 214, and an application interface 216. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

The network interface 214 (or interfaces) may support 3GPP reference points, such as Uu, N1, PC5, and so forth. Moreover, other network interfaces may be supported, as understood by one of ordinary skill in the art. The application interface 216 (or interfaces) may support various 3GPP defined APIs.

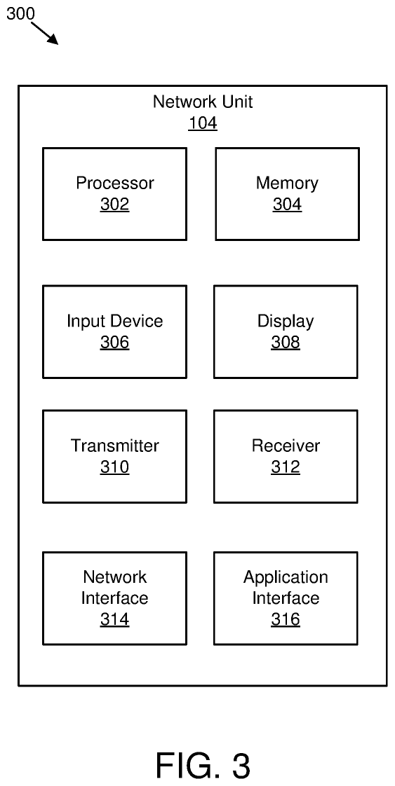

FIG. 3 depicts one embodiment of an apparatus 300 that may be used for adaptations based on a service continuity requirement. The apparatus 300 includes one embodiment of the network unit 104. Furthermore, the network unit 104 may include a processor 302, a memory 304, an input device 306, a display 308, a transmitter 310, a receiver 312, a network interface 314, and an application interface 316. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively. The network interface 314 (or interfaces) may support 3GPP reference points, such as Uu, N1, N2, N3, N33, N5, and so forth. Moreover, other network interfaces may be supported, as understood by one of ordinary skill in the art. The application interface 316 (or interfaces) may support various 3GPP defined APIs (e.g., northbound APIs).

In certain embodiments, the receiver 312 receives a service continuity requirement for one or more applications of one or more user equipments. In various embodiments, the processor 302: determines a query corresponding to a slice availability, a status at a target service area, or a combination thereof based on the service continuity requirement; determines a slice related adaptation for the application to maintain application service continuity based on the service continuity requirement and a slice parameter, wherein the slice related adaptation includes: an application mapping to a target slice at the target service area; a slice modification to extend slice availability to the target service area; a dynamic slice instantiation at the target service area; or some combination thereof; and translates the slice related adaptation to a trigger action for transmission to at least one network entity, at least one management entity, or a combination thereof. In certain embodiments, the transmitter 310 transmits the trigger action to the at least one network entity, the at least one management entity, or the combination thereof.

In some embodiments, the receiver 3312 receives a trigger action. In various embodiments, the processor 302 determines a network action based on the trigger action. In certain embodiments, the transmitter 310 transmits a response to the trigger action based on a result of the network action.

In certain embodiments, application service continuity may be established for configurations in which one or more mobile devices are moving to a different service area where a used slice is not supported (e.g., due to lack of capabilities), the used slice is not available, or the used slice is not preferable (e.g., due to different exposure capabilities and access capabilities at a target area).

In some embodiments, network slicing is a key fifth generation (“5G”) feature that uses logical end-to-end sub-networks corresponding to different verticals. Network slicing may enable deployment of multiple logical, self-contained networks, offering third parties and verticals customized services on top of a shared infrastructure. Based on a physical network that might be operated by a public operator or an enterprise, 5G may provide the means to run multiple slices for different communication purposes. Further, 5G may enable slices to run independently and/or isolated from each other.

In various embodiments, a network slice (e.g., private or public slice) may include a radio access network (“RAN”) part and a core network (“CN”) part. The support of network slicing may rely on a principle that traffic for different slices is handled by different protocol data unit (“PDU”) sessions. In certain embodiments, a network may realize different network slices by scheduling and providing different layer 1 (“L1”) and/or layer 2 (“L2”) configurations. Each network slice may be uniquely identified by a single (“S”) network slice selection assistance information (“NSSAI”) (“S-NSSAI”).

In some embodiments, NSSAI may include one or a list of S-NSSAIs where a S-NSSAI may be a combination of: 1) a mandatory slice and service type (“SST”) field that identifies the slice type and includes 8 bits (e.g., with a range of 0-255); and/or 2) an optional slice differentiator (“SD”) field which differentiates among slices with the same SST field and includes 24 bits.

In various embodiments, an S-NSSAI may not be supported homogenously within a 5G network of a public land mobile network (“PLMN”). If a user equipment (“UE”) moves around, intra radio access technology (“RAT”) (“intra-RAT”) handover may be triggered if a target access and mobility management function (“AMF”) or gNB does not support an S-NSSAI associated with one of the UE's PDU sessions, the S-NSSAI may be rejected by the target AMF or gNB, which may interrupt the service continuity and cause bad user experience.

In certain embodiments, an association of UEs to slices may be a core network feature, and may be transparent at an application side. In such embodiments, application support for slices may involve the interaction between a 5G system (“5GS”) (e.g., slice management system) and a third party (e.g., tenants) via management exposure for pre-commissioning, operation, and management of a slice end-to-end.

In some embodiments, an application may have preference on certain slices. This may occur if applications (e.g., gaming or online video applications) access a 5GS over multiple slices for different services (e.g., based on a user membership), or have different priorities on different slices based on an application service provider (“ASP”) request. Different slices may be available in all provided frequencies or a sub-set of them (e.g., frequency range 1 (“FR1”) or frequency range 2 (“FR2”)) based on a mobile network operator (“MNO”) and ASP agreement (and network capabilities to support a slice requirement). Different ASPs may use these slices (or a subset of them) for different services that they offer. If an application changes the network slices to be accessed, it may be agnostic to the UEs accessing the service and may be performed automatically. In such embodiments, a slice enablement layer may allow application to slice remapping based on a slice customer and/or ASP needs.

In various embodiments, ensuring slice availability may be important. In certain embodiments, a granularity of slice availability may be configured per tracking area and/or registration area within the PLMN.

In some embodiments: 1) multiple and different slices may be supported on different frequencies and/or access types; and/or 2) multiple and different slices may be supported in the same frequency layer in different regions.

In various embodiments, enhancements may be made for RAN slicing. Different factors that may impact slice continuity may include: 1) slice resource shortage for intra registration area (“RA”) (“Intra-RA”) mobility and inter RA (“Inter-RA”) mobility; 2) non-supported slices for Inter-RA mobility; 3) moving back for slice resource shortage for Intra-RA mobility and Inter-RA mobility; and/or 4) moving back for non-supported slices for Inter-RA mobility. As used herein, slice continuity may refer to the successful and undisrupted continuation of the application and/or UE associated with the ongoing network slice at a target area.

In certain embodiments, slice exposure capabilities may be different in different areas (e.g., some CN features and/or northbound application programming interfaces (“APIs”) are only available in some areas). Such embodiments may enable a trigger to change a target area of a slice to ensure meeting vertical and/or ASP exposure requirements.

In some embodiments, slice unavailability may impact a service and/or slice continuity resulting in a failure to meet UE requirements (e.g., slice or service requirements). This may lead to fallback to a different slice (e.g., with the same or lower quality of service (“QoS”)). Slice unavailability may impact all UEs of a target slice, which may share their resources with a target UE as well as a MNO that needs to ensure meeting a slice service level agreement (“SLA”) (e.g., performance and isolation key performance indicators (“KPIs”)). As may be appreciated, a signaling cost for slice fallback and/or reselection may impact application service continuity (e.g., for inter-RA mobility).

In certain embodiments, from a core network perspective, moving to a different RA may mean a change of CN functions (e.g., AMF) associated with the new RA. On the other hand, intra-RA mobility may not impact CN functions; however, a UE may need to be subscribed and/or registered for a target slice to perform reselection.

In some embodiments, slice availability may be enhanced by: 1) slice-based handover in RAN; 2) application to slice remapping in CN (e.g., via updating UE route selection policy (“URSP”) rules); 3) application to slice remapping at the UE side (e.g., via updating local policies); and/or 4) application to slice remapping at the slice enabler layer and/or SA6 middleware (e.g., acting as an application function (“AF”) via URSP rule guidance to a fifth generation core network (“5GC”)).

In various embodiments, an application may be registered and/or subscribed to a target slice and performance may be kept intact for the UEs which will be affected by a slice change. In certain embodiments, an entity that decides slice re-selection may evaluate and use criteria to trigger slice re-mapping to maintain application service continuity.

In certain embodiments, a mechanism may be used for application-enabled slice continuity support to deal with scenarios if one or more UEs are moving (or are expected and/or predicted to move) to an area where a slice is not supported or cannot offer the same performance (e.g., due to high load, frequencies and/or access type in a target area, a level of network and/or slice capability exposure).

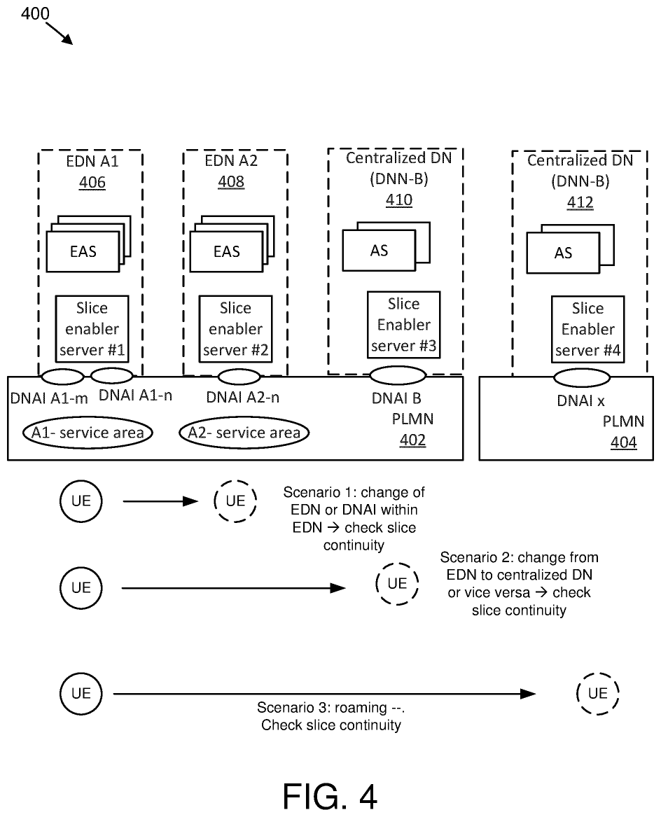

FIG. 4 is a schematic block diagram illustrating one embodiment of a system 400 for application service continuity. The system 400 includes a first PLMN 402, a second PLMN 404, a first edge data network (“EDN”) A1 406, a second EDN A2 408, a first centralized data network (“DN”) data network name (“DNN”) B (“DNN-B”) 410, and a second centralized DN DNN-B 412. As can be seen in FIG. 4, there may be different types of application service and slice continuity based on an expected UE mobility. In different scenarios, a current slice may not be available at the target area. In a first scenario (e.g., application service continuity (“ASC”) option 1), there may be a change of DN and/or EDN or a DNAI within a DN and/or EDN. In a second scenario (e.g., ASC option 2), there may be a change between an edge and central DN or vice versa. Moreover, in a third scenario (e.g., ASC option 3), there may be roaming between different PLMNs.

In some embodiments, an enablement entity may: 1) detect a trigger event and may be configured to transform the trigger event to a trigger action based on the event, a) such trigger event may be: an expected and/or predicted UE location and/or mobility change outside an edge service area, a high load indication for a given slice in a target service area, and/or a slice coverage reduction and/or slice scale in due to low demand, b) further, such trigger action may be: a query and/or request to a target node (e.g., responsible for slice to application service and/or UE mapping at the target area) to receive slice information and availability; 2) query and/or fetch a list of slices in the target area (e.g., where UEs are expected to move) and necessary slice information, permissions, exposure capabilities, and/or loads; 3) evaluate a need for slice related action, such as: a) slice remapping and to which slice to migrate to ensure meeting application KPIs, QOS, quality of experience (“QoE”) targets, and/or exposure requirements, b) slice lifecycle change and in particular slice coverage extension to enable a current slice to be available at a target area, and c) new slice creation and/or instantiation at the target area; 4) decide and/or recommend an actual or predictive slice related action (e.g., slice remapping, slice coverage extension, slice creation) for one or more applications of one or more UEs based on the evaluation; 5) send the slice related action as a trigger to a relevant entity, a) if this is a remapping requirement and/or recommendation, this may be sent to the application server and/or client, one or more 5GC entities, and other involved network slice enablers, and b) if this is a slice lifecycle change (e.g., modification, coverage extension, slice creation), this may be sent to an OAM and/or slice management system as a recommendation, guidance, and/or request; 6) trigger an application registration update for the target slice with a transmission toward the 5GC and/or the OAM, a) if this is a UE-specific action (e.g., remapping for the UE which is not registered to target slice), then a network slice capability management (“NSCM”) acting as an AF interacts with the 5GC to update the registration and/or slice subscription of the UE and requests and/or receives authorization and admission to access the new slice, b) if this is a slice-specific adaption (e.g., slice coverage extension, slice creation at target cell/area), then the affected UE may need to perform a registration update to enable extension of the service area to the target registration area (e.g., this may have also some interaction with OAM, for charging of the vertical and/or slice customer); and/or 7) after successful remapping, assist the mapping of the application to a new enablement entity for the target area (e.g., if the target area is covered by a different slice enabler).

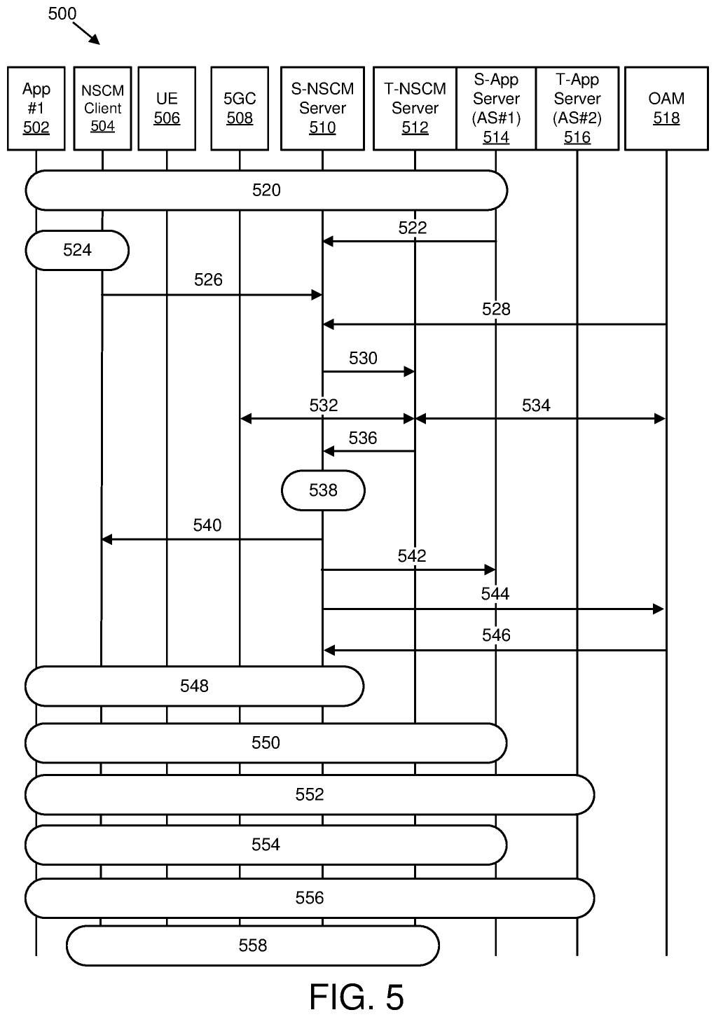

In a first embodiment, there may be service enabler architecture layer (“SEAL”) and/or NSCM enhancements. FIG. 5 is a schematic block diagram illustrating one embodiment of a system 500 having an enablement entity (e.g., SEAL NSCM server). The system 500 includes an application 502 (App #1), an NSCM client 504, a UE 506 (the App #1 502, NSCM client 504, and UE 506 may all be part of the same device-“UE1”), a 5GC 508, an S-NSCM server 510, a target (“T”) NSCM (“T-NSCM”) server 512, an S-App server (AS #1) 514, a T-App server (AS #2) 516, and an OAM 518. It should be noted that each illustrated communications may include one or more messages.

In a first communication 520, App #1 502 of UE1 is mapped to Slice #1, and the NSCM client 504 of UE1 has established a connection to the source (“S”) NSCM (“S-NSCM”) server 510 (NSCM server #1). A trigger event may then occur.

In a second communication 522, the S-App server 514 (e.g., may be a vertical application layer (“VAL”) server) sends a requirement to the S-NSCM server 510 to translate the possible UE and/or application related event (e.g., UE mobility outside the service area) to a slice related action (e.g., via slice remapping, slice preservation, slice configuration modification). The S-App server 514 may indicate one or more of the following: 1) an actual or expected and/or predicted UE1 mobility event to a target area outside an initial requested service area (or a predicted UE route which may require extension of the service area); 2) an expected DNAI and/or user plane (“UP”) path change for the UE1 which may be used by the S-NSCM server 510 as input to identify a slice relevant action; 3) a request to evaluate whether in a given area and/or time slice #1 may be supported, and, if not, to recommend a new slice or to trigger a network slice lifecycle change (e.g., network slice instance (“NSI”) and/or network slice subnet instance (“NSSI”) modification); 4) a request to handle the slice continuity support and decide the slice remapping on behalf of the server; and/or 5) an application preference to a list of slices (e.g., which may be a subset of subscribed slices) and an application preference to capabilities (e.g., spectrum bands, exposure capabilities) for the preferred list of slices.

In certain embodiments, App #1 502 client (e.g., VAL client) of UE1 triggers 524 a UE mobility change event (or expected and/or predicted event), a request to evaluate whether in a given area and/or time slice #1 can be supported, or a request to handle the slice or application service continuity support and decide the slice remapping on behalf of the server. In some embodiments, in a third communication 526, the NSCM client 504 may subscribe to the AS Layer of the UE to receive a notification on an expected and/or predicted handover to a neighboring RAN node.

In some embodiments, in a fourth communication 528, the OAM 518 (or slice management domain, or exposure governance management function (“EGMF”), or a respective management service) sends an indication to the S-NSCM server 510 for a network slice instance availability change. Such slice instance availability change may result from a lifecycle change or a change of the slice coverage and/or availability, a slice or slice subnet failure, slice capabilities, a slice scale in and/or out, and/or a slice SLA change.

In a fifth communication 530, the S-NSCM server 510 discovers a T-NSCM server 512 and sends to the T-NSCM server 512 (e.g., if the target area is covered by the T-NSCM server 512) a query to receive the available slices in a target area (e.g., list of S-NSSAIs) as well as the other information such as the capabilities, frequencies, access types, service and/or slice profiles, exposure levels and/or capabilities, and/or permissions based on the application type. As used herein, a service profile may be used to capture a set of requirements for a new network slice such as (e.g., eMBB, MIOT, URLLC) or to capture a set of specific industry requirements for creation of network slice such as vehicle to everything (“V2X”), smart grid, and/or remote healthcare. Moreover, as used herein, a slice profile may refer to an associated set of requirements (e.g., those derived from service level requirements) that are applicable to a network slice subnet constituents (e.g., RAN, transport, core network).

The S-NSCM server 510 may include an app and/or VAL server identity in the request message, so that the S-NSCM server 510 provides information that is relevant for the corresponding app and/or VAL server.

In a sixth communication 532, the T-NSCM server 512 acting as an AF, may interact with the 5GC 508 to query the UE specific information (e.g., location, UE connection capabilities) as well as network conditions (e.g., network monitoring from a network exposure function (“NEF”)) and/or slice related analytics on the slice load (e.g., from a network data analytics function (“NWDAF”)).

In a seventh communication 534, the T-NSCM server 512 may also interact with the OAM 518 to query about data slice and/or service profiles and management exposure capabilities at the target service area.

In an eighth communication 536, the T-NSCM server 512 sends to the S-NSCM server 510 the request information for the target area.

The S-NSCM server 510 checks 538 whether a new NSCM service area supports slice #1 and if slice #1 offers similar performance in a target area. It may be assumed that the S-NSCM server 510 is aware of per application QoS requirements and/or KPIs (or has acquired this information from the VAL server).

In certain embodiments, if slice #1 cannot be supported, is high loaded, or doesn't offer the same northbound APIs, the S-NSSAI determines a new slice for app #1 502 in the target area. It may be assumed that the new slice is able to serve the app and/or VAL client.

In some embodiments, the S-NSCM server 510 evaluates how the change of a slice will impact all the UEs within the target area, and optionally determines the remapping for other apps of the same or other UEs that may be affected by an app #1 502 change (e.g., some apps may have dependencies within the UE and it may be preferable to be within the same slice).

In various embodiments, if slice #1 cannot be supported and other slices are high loaded (or cannot offer the same performance), the S-NSCM server 510 requests from the OAM 518 the slice modification (e.g., slice coverage extension to the target registration area) or the slice #1 creation and/or instantiation at the target area (e.g., this may happen if a group of UEs are moving to the target area and use slice #1, so it may be beneficial to create slice #1 at the target area)

In a ninth communication 540 and/or a tenth communication 542, the S-NSCM server 510 sends a message to the NSCM client 504 or S-App server 514 (e.g., based on the type of trigger if it is via step 522 or 524), indicating either a response to the slice continuity request, or a notification that the current slice can or cannot be supported in the target area, and optionally a recommendation for an alternative slice (e.g., if the slice #1 is not supported or a list of alternative slices). This report may include the priorities, capabilities, and/or load of the alternative slices, as well as information on the T-NSCM server 512 which will be needed for the NSCM client 504 to server remapping.

In various embodiments, the S-NSCM server 510 may set and configure the NSCM client 504 and/or the S-App server 514 with a “slice-tailored” hysteresis threshold and policies for when to trigger a slice re-mapping for App #1 502 (e.g., after X ms/sec) to avoid remapping and moving back to the source area, but at the same time to make a switch on-time.

In an eleventh communication 544 and/or a twelfth communication 546, if there is a slice related adaptation or creation, to avoid changing the slice, the S-NSCM server 510 sends a request to a relevant management service of a respective management domain (e.g., via EGMF or directly) to modify the NSI and/or NSSI or create a new slice. Following this, the OAM 518 provides a positive or negative result. If the result is positive, steps 550, 552, 554, 556, and 558 are omitted.

In a thirteenth communication 548, the S-NSCM server 510 triggers a new registration transmission towards the 5GC 508 network to be able to access the target registration area and the target slice, or to update the registration of the UE 506 to cover the target registration area (e.g., based on the slice extension and/or creation).

In certain embodiments, the NSCM client 504 interacts with the App #1 502 client at the UE 506 side and the non-access stratum (“NAS”) layer to trigger registration to the target slice (e.g., UE interacts with 5GS via NAS signaling).

In some embodiments, depending on an ASC option, different steps may follow which involve the changing of EDN and/or DN, DNAI, EAS and/or VAL server, slice remapping, or any combination of them.

Specifically, in a fourteenth communication 550, there is an app remapping to a new EDN and/or DNAI (e.g., the S-App server 514 stays the same-a global server). Moreover, in a fifteenth communication 552, there is an app remapping to a new EDN and/or DNAI and an app server change (e.g., source to target EAS).

Further, in a sixteenth communication 554, there is an app remapping to a new EDN and/or DNAI and a slice remapping (e.g., if a current slice is not supported, based on SEAL NSCM procedures and/or AF guidance on URSP rules). Moreover, in a seventeenth communication 556, there is an app remapping to a new EDN and/or DNAI and an app server change (e.g., source to target EAS) and slice remapping (e.g., if a current slice is not supported, based on SEAL NSCM procedures and/or AF guidance on URSP rules).

In an eighteenth communication 558, if the NSCM client 504 needs to be remapped to a different NSCM server, the NSCM client 504 establishes a new connection with the T-NSCM server 512 and terminates the one with the S-NSCM server 510 (e.g., for subscription-based interaction), or for request-based interaction, it updates the mapping at the client side, and maintains the new NSCM server address and/or ID and may also request report configuration information for the target NSCM area.

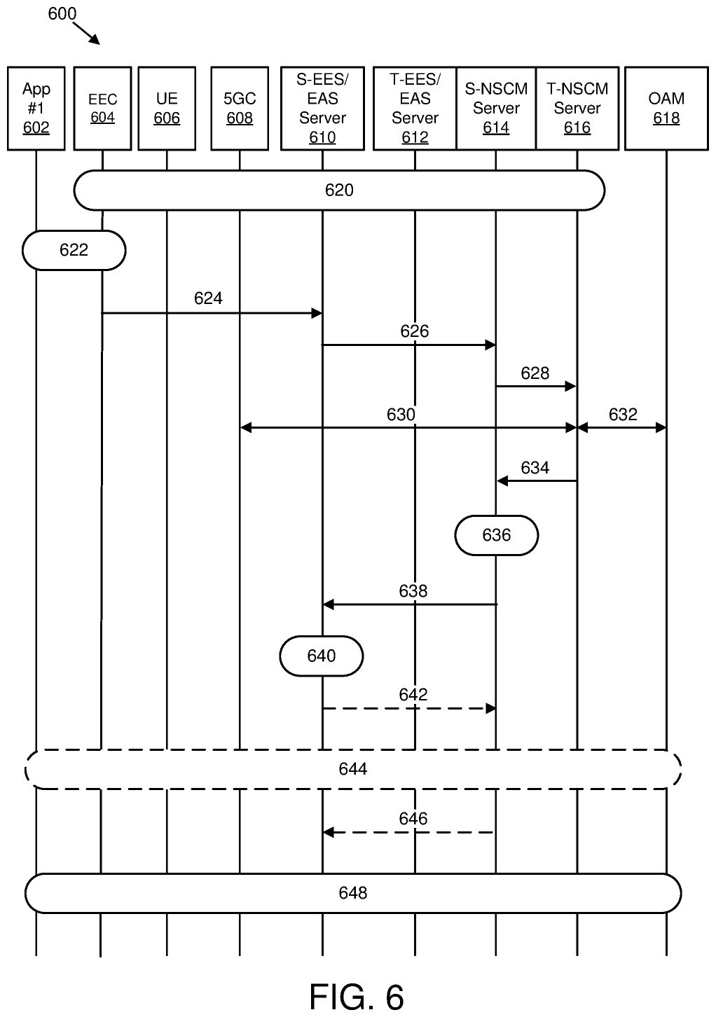

In a second embodiment, an EDGE app may be used. In the second embodiment, the slice enabler server (e.g., SEAL NSCM server) interacts with an edge enabler server (“EES”) to perform a slice related action triggered by an application service continuity service (e.g., by an EES and/or EDGE app layer). Specifically, FIG. 6 is a schematic block diagram illustrating another embodiment of a system 600 having an enablement entity (e.g., EES and/or EAS server). The system 600 includes an application 602 (App #1), an edge enabler client (“EEC”) 604, a UE 606 (the App #1 602, EEC 604, and UE 606 may all be part of the same device-“UE1”), a 5GC 608, an S-EES server 610 (or edge application server (“EAS”)), a T EES (“T-EES”) server 612 (or EAS), an S-NSCM server 614, a T-NSCM server 616, and an OAM 618. It should be noted that each illustrated communications may include one or more messages.

In a first communication 620, App #1 602 of UE1 is mapped to Slice #1, and the EEC 604 of UE1 has established a connection to the S-EES server 610. A trigger event may then occur.

In a second communication 622 and/or a third communication 624, the EEC 604 detects an actual and/or predicted UE mobility event and triggers application context relocation to the T-EES 612 and interacts with the S-EES server 610 to trigger EAS selection.

In a fourth communication 626, the S-EES server 610 requests from the S-NSCM server 614 what slices may be supported at a target EDN. This request includes a list of EAS IDs, a type of information needed (e.g., which slices, slice information, exposure capabilities, slice load measurements, stats, predictions, slice capabilities, generic network slice template (“GST”) parameters, and so forth).

In a fifth communication 628, the S-NSCM server 614 asks the T-NSCM 616 for what slices are available, slice information, load, exposure levels, and so forth. In particular, the S-NSCM server 614 discovers a T-NSCM 616 and sends to the T-NSCM 616 (e.g., if the target area is covered by the T-NSCM 616) a query to receive available slices in a target area (e.g., list of S-NSSAIs) as well as other information such as the capabilities, frequencies, access types, the slice profiles, slice SLA parameters, exposure levels, capabilities and permissions based on the application type, and so forth. The S-NSCM server 614 may include a EAS server ID and/or an AC ID in the request message, so that the S-NSCM server 614 provides information that is relevant for the corresponding app and/or VAL server.

In certain embodiments, in a sixth communication 630, the S-NSCM server 614 and/or the T-NSCM server 616 acting as an AF may interact with the 5GC 608 to query about UE specific information (e.g., location, UE connection capabilities) as well as network conditions (e.g., network monitoring from NEF) and/or slice related analytics on the slice load (e.g., from NWDAF).

In some embodiments, in a seventh communication 632, the T-NSCM server 616 may interact with the OAM 618 to query about data slice and/or service profiles and management exposure capabilities at the target service area.

In an eighth communication 634, the T-NSCM server 616 sends to the S-NSCM server 614 the request information for the target area.

The S-NSCM server 614 identifies 636 an action: 1) slice extension; 2) slice creation; or 3) slice remapping and, in a ninth communication 638, the S-NSCM server 614 responds to the S-EES server 610 with a report to identify a list of available slices in the target area and what action is recommended by the S-NSCM server 614 in case the slice is not available.

Such report may indicate one of the following: 1) this slice can be supported without slice lifecycle changes; 2) the slice may be supported but with slice lifecycle changes (and signaling cost to do that); 3) this slice cannot be supported, and a registration update is required for the AC; and/or 4) what other EASs and/or EDNs support the slice without a registration update and/or minimum signaling costs.

The S-EES server 610 checks 640 if new registration is required and may decide to modify the EAS and/or EDN selection for the AC to avoid registration updates or may ask S-NSCM to proceed with a registration update.

In an optional eleventh communication 642, if the S-EES server 610 decides to proceed with a slice related action (e.g., based on recommended options) that requires the registration update, the S-EES server 610 sends a request to the S-NSCM server 614 to proceed with the determined action.

In various embodiments, in an optional twelfth communication 644, steps 540, 542, 544, 546, 548, 550, 552, 554, 556, and 558 of the first embodiment may follow a registration update.

In an optional thirteenth communication 646, the S-NSCM server 614 sends a response with a positive or negative result of the request.

In a fourteenth communication 648, the S-EES server 610 proceeds with the application context relocation and/or transfer to the T-EES 612 or provides EAS re-selection or application context resolution (“ACR”) and/or ACT modification. If no registration update is needed, then the steps 642 and 646 may be omitted.

If the S-EES server 610 wants to change the EAS selection to avoid any registration update (e.g., to migrate to different edge and/or cloud which supports the slice #1), then EAS re-selection is initiated at the EEL.

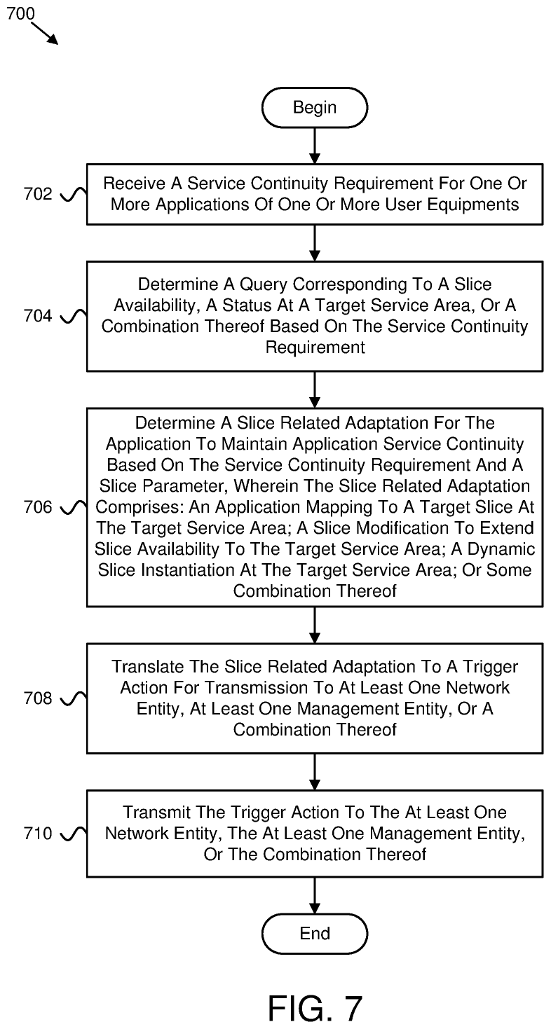

FIG. 7 is a flow chart diagram illustrating one embodiment of a method 700 for adaptations based on a service continuity requirement. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702 a service continuity requirement for one or more applications of one or more user equipments. In some embodiments, the method 700 includes determining 704 a query corresponding to a slice availability, a status at a target service area, or a combination thereof based on the service continuity requirement. In certain embodiments, the method 700 includes determining 706 a slice related adaptation for the application to maintain application service continuity based on the service continuity requirement and a slice parameter. The slice related adaptation includes: an application mapping to a target slice at the target service area; a slice modification to extend slice availability to the target service area; a dynamic slice instantiation at the target service area; or some combination thereof. In various embodiments, the method 700 includes translating 708 the slice related adaptation to a trigger action for transmission to at least one network entity, at least one management entity, or a combination thereof. In some embodiments, the method 700 includes transmitting 710 the trigger action to the at least one network entity, the at least one management entity, or the combination thereof.

In certain embodiments, the service continuity requirement is received from a communication layer of the user equipment, the application, an application server, or a combination thereof. In some embodiments, the method 700 further comprises receiving at least one slice parameter for supported slices of the application based on a mapping, wherein the at least one slice parameter comprises a generic network slice template parameter, a capability exposure level, a slice key performance indicator, a service profile, a slice profile, a slice template, application permissions over a supported slice, application restrictions over the supported slice, network data analytics for one or more supported slices, or some combination thereof. In various embodiments, the at least one slice parameter is determined by at least one management domain, a network domain, an application service provider, a third party provider, or some combination thereof.

In one embodiment, the query comprises requesting and receiving elements from a further control entity responsible for the target service area. In certain embodiments, the method 700 further comprises transmitting the query to obtain information about capabilities, conditions, or a combination thereof for: a network entity, a management entity, a user equipment, a data network, an edge platform, a cloud platform, an application server, or a combination thereof. In some embodiments, the method 700 further comprises receiving a response to the query, wherein the response comprises the capabilities, the conditions, or the combination thereof.

In various embodiments, the method 700 further comprises receiving a first mapping of the application to a first slice as part of the slice parameter. In one embodiment, the trigger action corresponds to a further registration, a registration update, or a combination thereof for the one or more user equipments to the network supporting the target slice at the target service area. In certain embodiments, the trigger action corresponds to triggering a slice modification, a slice creation, a slice provisioning, a slice parameter change, a user equipment route selection policy rule adaptation, a policy and charging control rule adaptation, a slice priority change, a slice preference change, a slice profile adaptation, a slice profile attribute remapping for the application, or a combination thereof for the at least one network entity, the at least one management entity, or the combination thereof.

In some embodiments, the method 700 further comprises receiving a response from the at least one network entity, the at least one management entity, or the combination thereof in response to the trigger action to indicate a result of the trigger action. In various embodiments, the service continuity requirement is received from an edge enabler client, an edge enabler server, an application enabler server, an application enabler client, or a combination thereof.

In one embodiment, the service continuity requirement comprises: an expected migration requirement for an application to a target service area; a predicted migration requirement for the application to the target service area; a requirement to check a slice continuity at the target service area; a requirement to support the slice continuity at the target service area; an expected handover of a user equipment to a target cell; a predicted handover of the user equipment to the target cell; the expected handover of the user equipment to a registration area; the predicted handover of the user equipment to the registration area; or some combination thereof. In certain embodiments, the method 700 further comprises transmitting a notification to a service provider of the one or more applications, the one or more applications of the one or more user equipments, or a combination thereof to indicate whether the slice related adaptation of the application is successful.

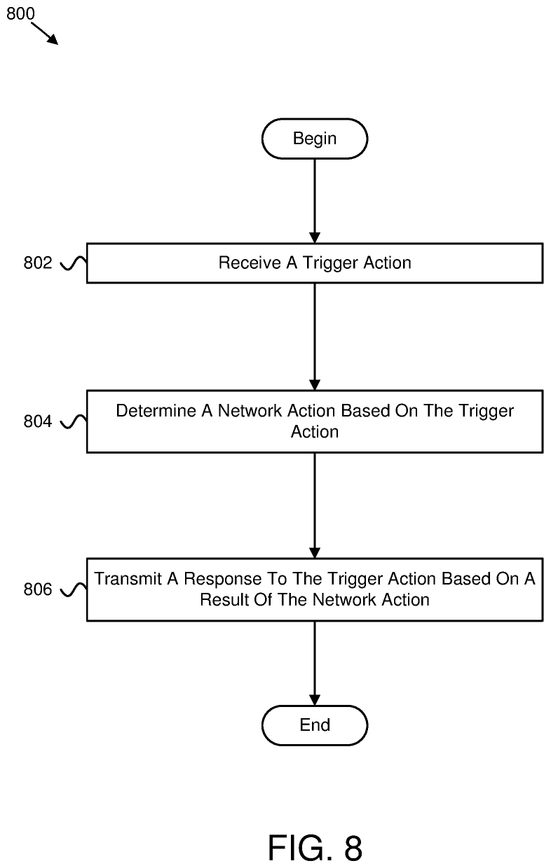

FIG. 8 is a flow chart diagram illustrating another embodiment of a method 800 for adaptations based on a service continuity requirement. In some embodiments, the method 800 is performed by an apparatus, such as the network unit 104. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802 a trigger action. In some embodiments, the method 800 includes determining 804 a network action based on the trigger action. In certain embodiments, the method 800 includes transmitting 806 a response to the trigger action based on a result of the network action.

In certain embodiments, a service continuity requirement is received from an application server. In some embodiments, the trigger action corresponds to a further registration, a registration update, or a combination thereof for the one or more user equipments to the network supporting a target slice at a target service area. In various embodiments, the trigger action corresponds to triggering a slice modification, a slice creation, a slice provisioning, a slice parameter change, a user equipment route selection policy rule adaptation, a policy and charging control rule adaptation, a slice priority change, a slice preference change, a slice profile adaptation, a slice profile attribute remapping for the application, or a combination thereof for at least one network entity, at least one management entity, or the combination thereof.

In one embodiment, a service continuity requirement comprises: an expected migration requirement for an application to a target service area; a predicted migration requirement for the application to the target service area; a requirement to check a slice continuity at the target service area; a requirement to support the slice continuity at the target service area; an expected handover of a user equipment to a target cell; a predicted handover of the user equipment to the target cell; the expected handover of the user equipment to a registration area; the predicted handover of the user equipment to the registration area; or some combination thereof.

In one embodiment, an apparatus comprises a control entity. The apparatus further comprises: a receiver that receives a service continuity requirement for one or more applications of one or more user equipments; a processor that: determines a query corresponding to a slice availability, a status at a target service area, or a combination thereof based on the service continuity requirement; determines a slice related adaptation for the application to maintain application service continuity based on the service continuity requirement and a slice parameter, wherein the slice related adaptation comprises: an application mapping to a target slice at the target service area; a slice modification to extend slice availability to the target service area; a dynamic slice instantiation at the target service area; or some combination thereof; and translates the slice related adaptation to a trigger action for transmission to at least one network entity, at least one management entity, or a combination thereof; and a transmitter that transmits the trigger action to the at least one network entity, the at least one management entity, or the combination thereof.

In certain embodiments, the service continuity requirement is received from a communication layer of the user equipment, the application, an application server, or a combination thereof.

In some embodiments, the receiver receives at least one slice parameter for supported slices of the application based on a mapping, wherein the at least one slice parameter comprises a generic network slice template parameter, a capability exposure level, a slice key performance indicator, a service profile, a slice profile, a slice template, application permissions over a supported slice, application restrictions over the supported slice, network data analytics for one or more supported slices, or some combination thereof.

In various embodiments, the at least one slice parameter is determined by at least one management domain, a network domain, an application service provider, a third party provider, or some combination thereof.

In one embodiment, the query comprises requesting and receiving elements from a further control entity responsible for the target service area.

In certain embodiments, the transmitter transmits the query to obtain information about capabilities, conditions, or a combination thereof for: a network entity, a management entity, a user equipment, a data network, an edge platform, a cloud platform, an application server, or a combination thereof.

In some embodiments, the receiver receives a response to the query, wherein the response comprises the capabilities, the conditions, or the combination thereof.

In various embodiments, the receiver receives a first mapping of the application to a first slice as part of the slice parameter.

In one embodiment, the trigger action corresponds to a further registration, a registration update, or a combination thereof for the one or more user equipments to the network supporting the target slice at the target service area.

In certain embodiments, the trigger action corresponds to triggering a slice modification, a slice creation, a slice provisioning, a slice parameter change, a user equipment route selection policy rule adaptation, a policy and charging control rule adaptation, a slice priority change, a slice preference change, a slice profile adaptation, a slice profile attribute remapping for the application, or a combination thereof for the at least one network entity, the at least one management entity, or the combination thereof.

In some embodiments, the receiver receives a response from the at least one network entity, the at least one management entity, or the combination thereof in response to the trigger action to indicate a result of the trigger action.

In various embodiments, the service continuity requirement is received from an edge enabler client, an edge enabler server, an application enabler server, an application enabler client, or a combination thereof.

In one embodiment, the service continuity requirement comprises: an expected migration requirement for an application to a target service area; a predicted migration requirement for the application to the target service area; a requirement to check a slice continuity at the target service area; a requirement to support the slice continuity at the target service area; an expected handover of a user equipment to a target cell; a predicted handover of the user equipment to the target cell; the expected handover of the user equipment to a registration area; the predicted handover of the user equipment to the registration area; or some combination thereof.

In certain embodiments, the transmitter transmits a notification to a service provider of the one or more applications, the one or more applications of the one or more user equipments, or a combination thereof to indicate whether the slice related adaptation of the application is successful.

In one embodiment, a method of a control entity comprises: receiving a service continuity requirement for one or more applications of one or more user equipments; determining a query corresponding to a slice availability, a status at a target service area, or a combination thereof based on the service continuity requirement; determining a slice related adaptation for the application to maintain application service continuity based on the service continuity requirement and a slice parameter, wherein the slice related adaptation comprises: an application mapping to a target slice at the target service area; a slice modification to extend slice availability to the target service area; a dynamic slice instantiation at the target service area; or some combination thereof; translating the slice related adaptation to a trigger action for transmission to at least one network entity, at least one management entity, or a combination thereof; and transmitting the trigger action to the at least one network entity, the at least one management entity, or the combination thereof.

In certain embodiments, the service continuity requirement is received from a communication layer of the user equipment, the application, an application server, or a combination thereof.

In some embodiments, the method further comprises receiving at least one slice parameter for supported slices of the application based on a mapping, wherein the at least one slice parameter comprises a generic network slice template parameter, a capability exposure level, a slice key performance indicator, a service, profile, a slice profile, a slice template, application permissions over a supported slice, application restrictions over the supported slice, network data analytics for one or more supported slices, or some combination thereof.

In various embodiments, the at least one slice parameter is determined by at least one management domain, a network domain, an application service provider, a third party provider, or some combination thereof.

In one embodiment, the query comprises requesting and receiving elements from a further control entity responsible for the target service area.

In certain embodiments, the method further comprises transmitting the query to obtain information about capabilities, conditions, or a combination thereof for: a network entity, a management entity, a user equipment, a data network, an edge platform, a cloud platform, an application server, or a combination thereof.

In some embodiments, the method further comprises receiving a response to the query, wherein the response comprises the capabilities, the conditions, or the combination thereof.

In various embodiments, the method further comprises receiving a first mapping of the application to a first slice as part of the slice parameter.

In one embodiment, the trigger action corresponds to a further registration, a registration update, or a combination thereof for the one or more user equipments to the network supporting the target slice at the target service area.

In certain embodiments, the trigger action corresponds to triggering a slice modification, a slice creation, a slice provisioning, a slice parameter change, a user equipment route selection policy rule adaptation, a policy and charging control rule adaptation, a slice priority change, a slice preference change, a slice profile adaptation, a slice profile attribute remapping for the application, or a combination thereof for the at least one network entity, the at least one management entity, or the combination thereof.

In some embodiments, the method further comprises receiving a response from the at least one network entity, the at least one management entity, or the combination thereof in response to the trigger action to indicate a result of the trigger action.

In various embodiments, the service continuity requirement is received from an edge enabler client, an edge enabler server, an application enabler server, an application enabler client, or a combination thereof.

In one embodiment, the service continuity requirement comprises: an expected migration requirement for an application to a target service area; a predicted migration requirement for the application to the target service area; a requirement to check a slice continuity at the target service area; a requirement to support the slice continuity at the target service area; an expected handover of a user equipment to a target cell; a predicted handover of the user equipment to the target cell; the expected handover of the user equipment to a registration area; the predicted handover of the user equipment to the registration area; or some combination thereof.

In certain embodiments, the method further comprises transmitting a notification to a service provider of the one or more applications, the one or more applications of the one or more user equipments, or a combination thereof to indicate whether the slice related adaptation of the application is successful.

In one embodiment, an apparatus comprises a network device. The apparatus further comprises: a receiver that receives a trigger action; a processor that determines a network action based on the trigger action; and a transmitter that transmits a response to the trigger action based on a result of the network action.

In certain embodiments, a service continuity requirement is received from an application server.

In some embodiments, the trigger action corresponds to a further registration, a registration update, or a combination thereof for the one or more user equipments to the network supporting a target slice at a target service area.

In various embodiments, the trigger action corresponds to triggering a slice modification, a slice creation, a slice provisioning, a slice parameter change, a user equipment route selection policy rule adaptation, a policy and charging control rule adaptation, a slice priority change, a slice preference change, a slice profile adaptation, a slice profile attribute remapping for the application, or a combination thereof for at least one network entity, at least one management entity, or the combination thereof.

In one embodiment, a service continuity requirement comprises: an expected migration requirement for an application to a target service area; a predicted migration requirement for the application to the target service area; a requirement to check a slice continuity at the target service area; a requirement to support the slice continuity at the target service area; an expected handover of a user equipment to a target cell; a predicted handover of the user equipment to the target cell; the expected handover of the user equipment to a registration area; the predicted handover of the user equipment to the registration area; or some combination thereof.

In one embodiment, a method of a network device comprises: receiving, at a network device, a trigger action; determining a network action based on the trigger action; and transmitting a response to the trigger action based on a result of the network action.

In certain embodiments, a service continuity requirement is received from an application server.

In some embodiments, the trigger action corresponds to a further registration, a registration update, or a combination thereof for the one or more user equipments to the network supporting a target slice at a target service area.

In various embodiments, the trigger action corresponds to triggering a slice modification, a slice creation, a slice provisioning, a slice parameter change, a user equipment route selection policy rule adaptation, a policy and charging control rule adaptation, a slice priority change, a slice preference change, a slice profile adaptation, a slice profile attribute remapping for the application, or a combination thereof for at least one network entity, at least one management entity, or the combination thereof.

In one embodiment, a service continuity requirement comprises: an expected migration requirement for an application to a target service area; a predicted migration requirement for the application to the target service area; a requirement to check a slice continuity at the target service area; a requirement to support the slice continuity at the target service area; an expected handover of a user equipment to a target cell; a predicted handover of the user equipment to the target cell; the expected handover of the user equipment to a registration area; the predicted handover of the user equipment to the registration area; or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a control entity function, the apparatus comprising:
at least one memory; and
at least one processor coupled with the at least one memory and configured to cause the apparatus to:
receive a service continuity requirement for one or more applications of one or more user equipments (UEs);
determine a query corresponding to a slice availability, a status at a target service area, or a combination thereof based on the service continuity requirement;
determine a slice related adaptation for the application to maintain application service continuity based on the service continuity requirement and a slice parameter, wherein the slice related adaptation comprises:
an application mapping to a target slice at the target service area;
a slice modification to extend slice availability to the target service area;
a dynamic slice instantiation at the target service area;
or a combination thereof;
translate the slice related adaptation to a trigger action for transmission to at least one network entity, at least one management entity, or a combination thereof; and
transmit the trigger action to the at least one network entity, the at least one management entity, or the combination thereof.

2. The apparatus of claim 1, wherein the service continuity requirement is received from a communication layer of the UE, the application, a network entity, an application server, or a combination thereof.

3. The apparatus of claim 1, wherein the at least one processor is configured to cause the apparatus to receive at least one slice parameter for supported slices of the application based on a mapping, wherein the at least one slice parameter comprises a generic network slice template parameter, a capability exposure level, a slice key performance indicator, a service profile, slice profile, a slice template, application permissions over a supported slice, application restrictions over the supported slice, network data analytics for one or more supported slices, or a combination thereof.

4. The apparatus of claim 3, wherein the at least one slice parameter is determined by at least one management domain, a network domain, an application service provider, a third party provider, or a combination thereof.

5. The apparatus of claim 1, wherein the query comprises requesting and receiving elements from a further control entity responsible for the target service area.

6. The apparatus of claim 1, wherein the at least one processor is configured to cause the apparatus to transmit the query to obtain information about capabilities, conditions, or a combination thereof for: a network entity, a management entity, a UE, a data network, an edge platform, a cloud platform, an application server, or a combination thereof.

7. The apparatus of claim 6, wherein the at least one processor is configured to cause the apparatus to receive a response to the query, wherein the response comprises the capabilities, the conditions, or the combination thereof.

8. The apparatus of claim 1, wherein the at least one processor is configured to cause the apparatus to receive a first mapping of the application to a first slice as part of the slice parameter.

9. The apparatus of claim 1, wherein the trigger action corresponds to a further registration, a registration update, or a combination thereof for the one or more (UEs) to the network supporting the target slice at the target service area.

10. The apparatus of claim 1, wherein the trigger action corresponds to triggering a slice modification, a slice creation, a slice provisioning, a slice parameter change, a UE route selection policy rule adaptation, a policy and charging control rule adaptation, a slice priority change, a slice preference change, a slice profile adaptation, a slice profile attribute remapping for the application, or a combination thereof for the at least one network entity, the at least one management entity, or the combination thereof.

11. The apparatus of claim 1, wherein the at least one processor is configured to cause the apparatus to receive a response from the at least one network entity, the at least one management entity, or the combination thereof in response to the trigger action to indicate a result of the trigger action.

12. The apparatus of claim 1, wherein the service continuity requirement is received from an edge enabler client, an edge enabler server, an application enabler server, an application enabler client, or a combination thereof.

13. The apparatus of claim 1, wherein the service continuity requirement comprises:
an expected migration requirement for an application to a target service area;
a predicted migration requirement for the application to the target service area;
a requirement to check a slice continuity at the target service area;
a requirement to support the slice continuity at the target service area;
an expected handover of a UE to a target cell;
a predicted handover of the UE to the target cell;
the expected handover of the UE to a registration area;
the predicted handover of the UE to the registration area;
or a combination thereof.

14. A method at a control entity, the method comprising:
receiving a service continuity requirement for one or more applications of one or more user equipments (UEs);
determining a query corresponding to a slice availability, a status at a target service area, or a combination thereof based on the service continuity requirement;
determining a slice related adaptation for the application to maintain application service continuity based on the service continuity requirement and a slice parameter, wherein the slice related adaptation comprises:
an application mapping to a target slice at the target service area;
a slice modification to extend slice availability to the target service area;
a dynamic slice instantiation at the target service area;
or a combination thereof;
translating the slice related adaptation to a trigger action for transmission to at least one network entity, at least one management entity, or a combination thereof; and
transmitting the trigger action to the at least one network entity, the at least one management entity, or the combination thereof.

15. An apparatus for performing a network function, the apparatus comprising:
at least one memory; and
at least one processor coupled with the at least one memory and configured to cause the apparatus to:
receive a trigger action;
determine a network action based on the trigger action; and
transmit a response to the trigger action based on a result of the network action.

16. A method at a network function, the method comprising:
receiving receive a trigger action;
determining a network action based on the trigger action; and
transmitting a response to the trigger action based on a result of the network action.

17. The method of claim 14, further comprising receiving the service continuity requirement from a communication layer of the UE, the application, a network entity, an application server, or a combination thereof.

18. The method of claim 14, further comprising receiving at least one slice parameter for supported slices of the application based on a mapping, wherein the at least one slice parameter comprises a generic network slice template parameter, a capability exposure level, a slice key performance indicator, a service profile, slice profile, a slice template, application permissions over a supported slice, application restrictions over the supported slice, network data analytics for one or more supported slices, or a combination thereof.

19. The method of claim 18, further comprising determining the at least one slice parameter by at least one management domain, a network domain, an application service provider, a third party provider, or a combination thereof.

20. The method of claim 14, further comprising requesting and receiving elements from a further control entity responsible for the target service area.
